(19) United States
(12) Patent Application Publication
(10) Pub. No.: US 2026/0296414 A1
(43) Pub. Date: Oct. 1, 2026

(54) DRIVING ASSISTANCE DEVICE AND COMPUTER PROGRAM

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Mikio OKUDA, Tokyo (JP); Shotaro YAMAZAKI, Atsugi-shi (JP)

(21) Appl. No.: 19/577,923

(22) Filed: Mar. 25, 2026

(30) Foreign Application Priority Data
Mar. 27, 2025 (JP) 2025-053527

(51) Int. Cl. B60W 30/09; B60W 30/095; G06V 10/60; G06V 10/80; G06V 20/58

(52) U.S. Cl. CPC B60W 30/09; B60W 30/0956; G06V 10/60; G06V 10/80; G06V 20/58; B60W 2420/403; B60W 2556/35; G06V 2201/07

(57) ABSTRACT

A driving assistance device for a vehicle includes a point cloud data acquisition unit that acquires point cloud data of an object target in time series using a sensor mounted on the vehicle, an image acquisition unit that acquires a captured image of the object target in time series using a camera mounted on the vehicle, a fusion unit that combines the captured image, parameters of which satisfy a predetermined criterion, with the point cloud data to generate a fusion target of the object target, and a collision avoidance control suppression unit that suppresses collision avoidance control from being executed for avoiding a collision between the vehicle and the object target traveling ahead of the vehicle. The collision avoidance control suppression unit suppresses collision avoidance control from being executed when a part of the object target is located outside an angle of view of the camera.

### CROSS-REFERENCE TO RELATED APPLICATION

This application is based on and claims the benefit of priority from earlier Japanese Patent Application No. 2025-53527 filed on March 27, 2025, the descriptions of which are incorporated herein by reference.

### TECHNICAL FIELD

The present disclosure relates to a driving assistance device and a computer program.

### BACKGROUND

JP 2005-145396 A discloses a technology that combines image information obtained by a camera with radar information obtained by a millimeter-wave radar to generate a fusion target, and uses this to recognize a preceding vehicle a lane in which an own vehicle is traveling.

### SUMMARY

The present disclosure can be realized in the following aspects:

According to one aspect of the present disclosure, a driving assistance device for a vehicle is provided. The driving assistance device includes a point cloud data acquisition unit that acquires point cloud data of an object target in time series using a sensor mounted on the vehicle, an image acquisition unit that acquires a captured image of the object target in time series using a camera mounted on the vehicle, a fusion unit that combines the captured image, parameters of which satisfy a predetermined criterion, with the point cloud data to generate a fusion target of the object target, and a collision avoidance control suppression unit that suppresses collision avoidance control from being executed for avoiding a collision between the vehicle and the object target traveling ahead of the vehicle. The collision avoidance control suppression unit suppresses collision avoidance control from being executed when a part of the object target is located outside an angle of view of the camera.

According to another aspect of the present disclosure, a driving assistance device for a vehicle is provided. The driving assistance device includes a point cloud data acquisition unit that acquires point cloud data of an object target in time series using a sensor mounted on the vehicle, an image acquisition unit that acquires a captured image of the object target in time series using a camera mounted on the vehicle, a fusion unit that combines the captured image, parameters of which satisfy a predetermined criterion, with the point cloud data to generate a fusion target of the object target, and a collision avoidance control suppression unit that suppresses collision avoidance control from being executed for avoiding a collision between the vehicle and the object target traveling ahead of the vehicle. The fusion unit generates the fusion target at a first period by using the captured image acquired at a second period occurring earlier than the first period when the captured image is not acquired at the first period or when the parameters related to the captured image acquired at the first period do not satisfy the predetermined criterion, and the collision avoidance control suppression unit suppresses the collision avoidance control from being executed when the fusion target at the first period is generated using the captured image acquired at the second period.

### BRIEF DESCRIPTION OF THE DRAWINGS

The above features of the present disclosure will be made clearer by the following detailed description, given referring to the appended drawings. In the accompanying drawings:

FIG. 1 is a block diagram showing a schematic configuration of a driving assistance device according to a first embodiment;

FIG. 2 shows a flowchart of a procedure of a fusion target generation process in the first embodiment;

FIG. 3 shows a flowchart of a determination process procedure in the first embodiment;

FIG. 4 shows an explanatory diagram for explaining that a part of an object target is located outside an angle of view of a camera;

FIG. 5 shows an explanatory diagram for explaining a generation of an imaginary object target;

FIG. 6 shows a flowchart of a procedure of a determination process in a second embodiment; and

FIG. 7 shows a flowchart of a procedure of a determination process in a third embodiment.

### DETAILED DESCRIPTION OF THE PREFERRED EMBODIMENTS

Due to driving conditions of a vehicle or a malfunction of a camera mounted on the vehicle, situations may arise in which the camera is temporarily unable to detect an object target, or the detection accuracy of the object target detected by the camera may decrease. The fusion target generated under such circumstances may have lower accuracy of position information compared to a normal fusion target. This may result in unnecessary control being executed to avoid a collision with an imaginary object target.

The present disclosure can be realized in the following aspects:

According to one aspect of the present disclosure, a driving assistance device for a vehicle is provided. The driving assistance device includes a point cloud data acquisition unit that acquires point cloud data of an object target in time series using a sensor mounted on the vehicle, an image acquisition unit that acquires a captured image of the object target in time series using a camera mounted on the vehicle, a fusion unit that combines the captured image, parameters of which satisfy a predetermined criterion, with the point cloud data to generate a fusion target of the object target, and a collision avoidance control suppression unit that suppresses collision avoidance control from being executed for avoiding a collision between the vehicle and the object target traveling ahead of the vehicle. The collision avoidance control suppression unit suppresses collision avoidance control from being executed when a part of the object target is located outside an angle of view of the camera.

According to this aspect of the driving assistance device, the collision avoidance control suppression unit suppresses collision avoidance control from being executed when a part of the object target is located outside the angle of view of the camera, thereby suppressing collision avoidance control from being executed for the fusion target generated in a situation where a part of the object target is located outside the angle of view of the camera, i.e., the fusion target whose position information accuracy may be reduced compared to a normal fusion target. Therefore, unnecessary collision avoidance control can be suppressed from being executed for an imaginary object target.

According to another aspect of the present disclosure, a driving assistance device for a vehicle is provided. The driving assistance device includes a point cloud data acquisition unit that acquires point cloud data of an object target in time series using a sensor mounted on the vehicle, an image acquisition unit that acquires a captured image of the object target in time series using a camera mounted on the vehicle, a fusion unit that combines the captured image, parameters of which satisfy a predetermined criterion, with the point cloud data to generate a fusion target of the object target, and a collision avoidance control suppression unit that suppresses collision avoidance control from being executed for avoiding a collision between the vehicle and the object target traveling ahead of the vehicle. The fusion unit generates the fusion target at a first period by using the captured image acquired at a second period occurring earlier than the first period when the captured image is not acquired at the first period or when the parameters related to the captured image acquired at the first period do not satisfy the predetermined criterion, and the collision avoidance control suppression unit suppresses the collision avoidance control from being executed when the fusion target at the first period is generated using the captured image acquired at the second period.

According to this aspect of the driving assistance device, the collision avoidance control suppression unit suppresses collision avoidance control from being executed when the fusion target at the first period is generated using the image acquired at the second period, thereby suppressing collision avoidance control from being executed for the fusion target at a time other than the time when the image was acquired, i.e., a fusion target whose position information may have lower accuracy compared to a normal fusion target. Therefore, unnecessary collision avoidance control can be suppressed from being executed for an imaginary object target.

### A. First Embodiment

### A1. Overall Configuration of a Driving Assistance Device 100

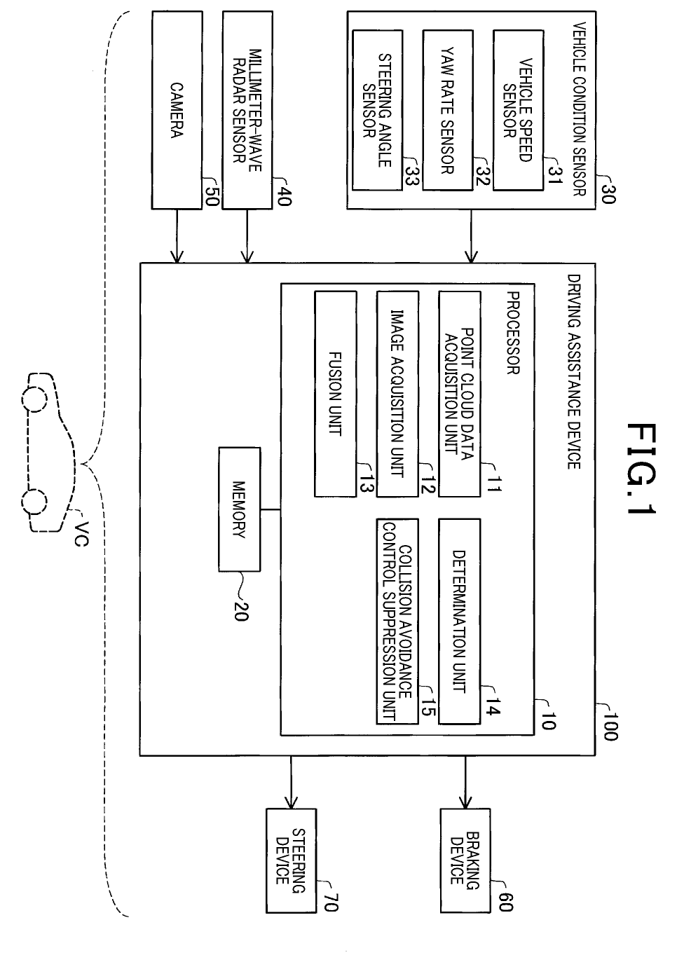

A driving assistance device 100 shown in FIG. 1 is mounted on a vehicle VC and is used to assist in driving the vehicle VC. In the present embodiment, the vehicle VC is also referred to as an own vehicle VC. The vehicle VC may be any vehicle, such as an internal combustion engine vehicle, a hybrid electric vehicle (HEV), a plug-in hybrid electric vehicle (PHEV), an electric vehicle (EV), or a fuel cell vehicle (FCV, FCHV). The vehicle VC is configured to be switchable between autonomous driving and manual driving. The autonomous driving refers to driving in which drive control, brake control, and steering control are performed automatically in place of a driver. The manual driving refers to driving in which the driver performs operations for drive control, brake control, and steering control.

As shown in FIG. 1, the vehicle VC is equipped with the driving assistance device 100, a vehicle condition sensor 30, a millimeter-wave radar sensor 40, a camera 50, a braking device 60, and a steering device 70. The driving assistance device 100 is connected to the vehicle condition sensor 30, the millimeter-wave radar sensor 40, the camera 50, the braking device 60, and the steering device 70 via an in-vehicle network so as to be able to communicate with each other. An example of an in-vehicle network is a CAN (Controller Area Network). The driving assistance device 100 assists driving by controlling the braking device 60 and the steering device 70 using information obtained from the vehicle condition sensor 30, the millimeter-wave radar sensor 40, and the camera 50.

The vehicle condition sensor 30 detects the running condition of the vehicle VC. The vehicle condition sensor 30 includes a vehicle speed sensor 31, a yaw rate sensor 32, and a steering angle sensor 33. The vehicle speed sensor 31 measures the speed of the vehicle VC. The yaw rate sensor 32 detects the yaw rate (rotational angular velocity) around the vertical axis of the center of gravity of the vehicle VC. The steering angle sensor 33 detects the steering angle of the vehicle VC.

The millimeter-wave radar sensor 40 detects targets present around the vehicle VC. Hereinafter, a target detected around the vehicle VC will be referred to as an object target TG. The millimeter-wave radar sensor 40 corresponds to a sensor in the present disclosure. The millimeter-wave radar sensor 40 may be mounted, for example, inside a front grille of the vehicle VC. The millimeter-wave radar sensor 40 generates point cloud data by receiving reflected waves of the emitted millimeter-waves. The point cloud data includes information such as the reception strength of the reflected waves, the azimuth angle of the ranging point where the millimeter-waves are reflected, the distance to the ranging point, the relative speed of the ranging point, and the time when the ranging point was obtained. The point cloud data generated by the millimeter-wave radar sensor 40 is output to a point cloud data acquisition unit 11, which will be described later.

The camera 50 is an image sensor for detecting the object target TG. The camera 50 may be, for example, a monocular camera. n the present embodiment, the camera 50 is mounted near an upper edge of a windshield of the vehicle VC and captures images of an area ahead of the vehicle VC. The image captured by the camera 50 is output to an image acquisition unit 12, which will be described later.

The braking device 60 applies a braking force to the vehicle VC to brake the vehicle VC. In a case of manual driving, the braking device 60 applies braking force in response to the driver's depression of a brake pedal. In a case of autonomous driving, the braking device 60 applies braking force in response to an instruction from the driving assistance device 100 via the in-vehicle network.

The steering device 70 applies a steering torque to the vehicle VC. In a case of manual driving, the steering device 70 applies a steering torque in response to an operation of a steering wheel performed by the driver of the vehicle VC. In a case of autonomous driving, the steering device 70 applies a steering torque in response to an instruction from the driving assistance device 100 via the in-vehicle network.

The driving assistance device 100 is configured as a computer including a processor 10 and a memory 20. The computer may be, for example, an ECU (Electronic Control Unit). The processor 10 functions as the point cloud data acquisition unit 11, the image acquisition unit 12, a fusion unit 13, a determination unit 14, and a collision avoidance control suppression unit 15 by executing a program pre-stored in the memory 20.

The point cloud data acquisition unit 11 utilizes the millimeter-wave radar sensor 40 mounted on the own vehicle VC to acquire point cloud data of the object target TG detected in the vicinity of the own vehicle VC in a time series manner. The point cloud data is held for a certain period of time in the point cloud data acquisition unit 11 and then used to generate a fusion target, which will be described later.

The image acquisition unit 12 acquires images of the object target TG in time series using the camera 50 mounted on the vehicle VC. The captured image is held for a certain period of time in the image acquisition unit 12 and then used to generate the fusion target, which will be described later. In the present embodiment, the timing at which the captured image is acquired is set to be the same as the timing at which the point cloud data is acquired.

The fusion unit 13 combines the captured image, parameters of which satisfy predetermined criteria, with the point cloud data to generate a virtual object target TG. Hereinafter, the virtual object target TG generated by combining the above-mentioned captured image and point cloud data will be referred to as the fusion target FT. The fusion target FT is generated using known sensor fusion techniques. Sensor fusion technique is a technique that acquires highly reliable information by using a plurality of sensors to detect information that is difficult to detect with a single sensor.

The fusion unit 13 normally generates the fusion target FT by combining point cloud data and captured images acquired at the same time. However, as described later, in cases where an image is not acquired temporarily or where parameters related to the acquired image do not satisfy predetermined criteria, the fusion unit 13 generates a fusion target FT using an image acquired at a time different from the time when the point cloud data was acquired. The parameters relating to the captured image will be described later. Note that the present disclosure is based on the premise that point cloud data is acquired continuously with high reliability.

The determination unit 14 uses the generated fusion target FT to determine whether a situation is such that there is a risk of the own vehicle VC colliding with the object target TG. In addition, in a collision avoidance control suppression process described later, the determination unit 14 performs various determinations in a plurality of steps related to whether the own vehicle VC will collide with the object target TG and whether to execute collision avoidance control.

The collision avoidance control suppression unit 15 suppresses collision avoidance control from being performed for avoiding a collision between the own vehicle VC and an object target TG traveling ahead of the own vehicle VC. Collision avoidance control is control for avoiding a collision between the own vehicle VC and the object target TG, and in the present embodiment, the braking device 60 applies a braking force to the own vehicle VC to decelerate the own vehicle VC until it reaches or falls below a predetermined threshold speed. Collision avoidance control is executed in response to an instruction sent from the driving assistance device 100 to the braking device 60 via the in-vehicle network.

### A2. Collision Avoidance Control Determination Process

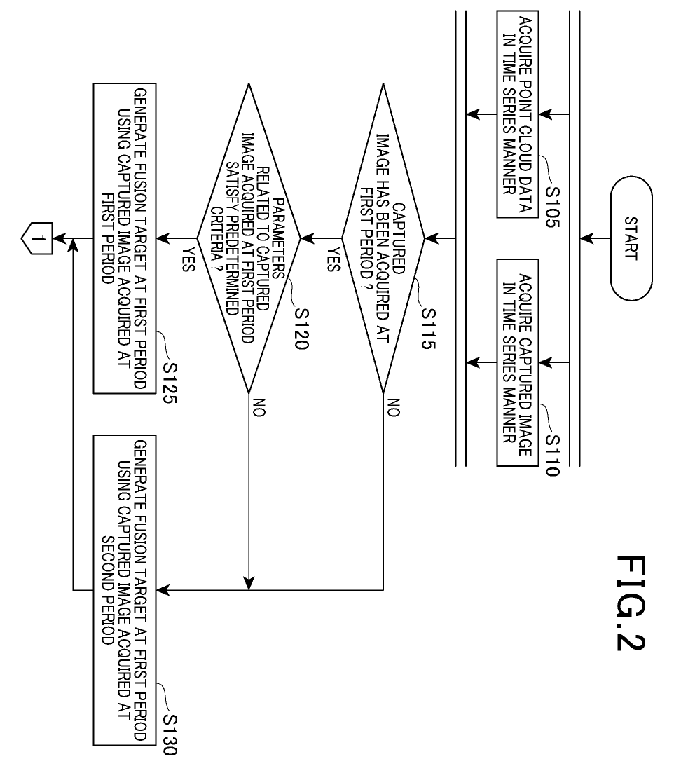

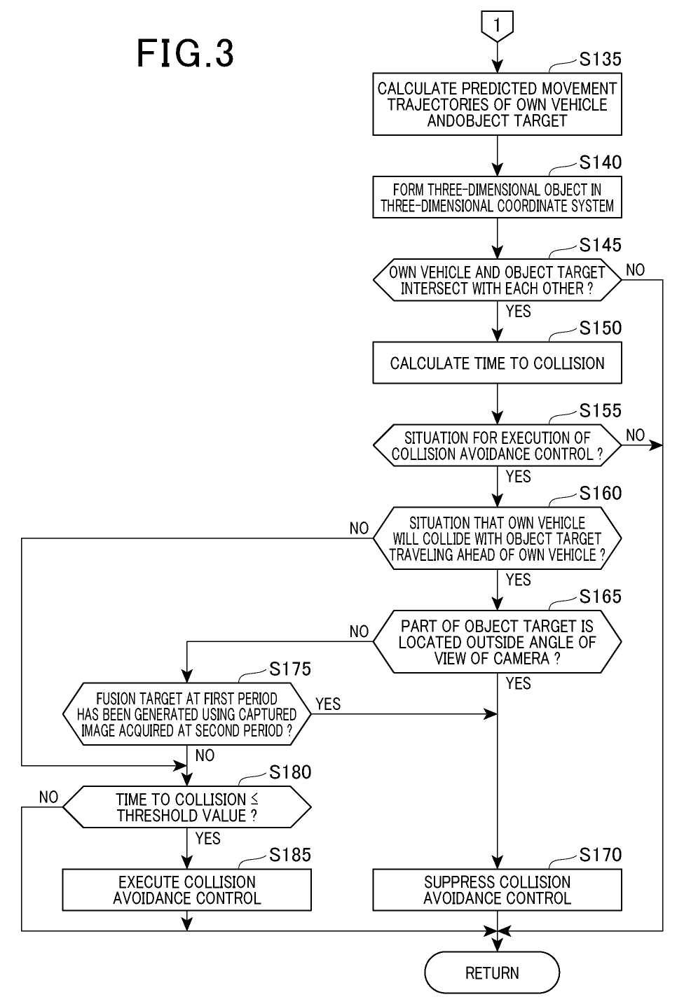

A collision avoidance control determination process shown in FIGS. 2 and 3 refers to a process for determining whether the collision avoidance control suppression unit 15 executes collision avoidance control. The collision avoidance control determination process is started when the driving assistance device 100 is started.

### A2-1. Fusion Target Generation Process

A fusion target generation process shown in FIG. 2 refers to a process performed by the fusion unit 13 to generate a fusion target FT. The fusion target generation process is started when the driving assistance device 100 is started.

In step S105, the point cloud data acquisition unit 11 uses the millimeter-wave radar sensor 40 mounted on the own vehicle VC to acquire point cloud data of the object target TG detected in the vicinity of the own vehicle VC in a time series manner. Hereinafter, step S will be simply referred to as S. The point cloud data is held for a certain period of time in the point cloud data acquisition unit 11, and then used to generate a fusion target FT in S125 or S130, which will be described later.

In parallel with S105, in S110, the image acquisition unit 12 acquires a captured image of the object target TG using the camera 50 mounted on the own vehicle VC in a time series manner. The captured image is held for a certain period of time in the image acquisition unit 12, and then used to generate a fusion target FT in S125 or S130, which will be described later. In the present embodiment, the timing at which the captured image is acquired is set to be the same as the timing at which the point cloud data is acquired.

In S115, the fusion unit 13 determines whether a captured image has been acquired at a first period. The first period means any period at which a captured image is acquired.

If a captured image is acquired at the first period (S115: Yes), the fusion unit 13 determines whether parameters related to the captured image acquired at the first period satisfy the predetermined criteria in S120. In the present embodiment, the parameters related to the captured image include information related to the brightness of the captured image. A case where the parameters related to the captured image satisfy the predetermined criteria means a case where the brightness of the captured image is equal to or greater than a predetermined threshold value. The predetermined threshold value may be set, for example, taking into consideration whether the object target TG can be detected in the acquired captured image, and whether the detected object target TG can be clearly recognized.

If the parameters related to the captured image acquired at the first period satisfy the predetermined criteria (S120: Yes), the fusion unit 13 generates a fusion target FT at the first period using the captured image acquired at the first period in S125. That is, in this case, the fusion unit 13 generates the fusion target FT using the captured image acquired at the same time as the point cloud data was acquired.

On the other hand, if an image is not acquired at the first period (S115: No), the fusion unit 13 generates a fusion target FT at the first period using an image acquired at a second period occurring earlier than the first period in S130. That is, in this case, the fusion unit 13 generates a fusion target FT using a captured image acquired at a time different from the time when the point cloud data was acquired. Possible reasons for the failure to acquire a captured image at the first period include, for example, a failure of the camera 50, the image acquisition unit 12, or the in-vehicle network. Note that the captured image acquired at the second period in S130 is a captured image whose parameters satisfy the predetermined criteria.

In addition, even if an image is acquired at the first period (S115: Yes), if the parameters related to the image acquired at the first period do not satisfy the predetermined criteria (S120: No), the above-mentioned S130 is executed. A case where the parameters relating to the captured image do not satisfy the predetermined criteria refers to a case where the brightness of the captured image is less than a predetermined threshold value. Possible reasons for the brightness of the captured image being below a predetermined threshold include, for example, the presence of an obstacle such as a vehicle between the camera 50 and the object target TG, or the vehicle VC traveling at night or in bad weather.

An accuracy of position information of a fusion target FT generated using an image whose parameters do not satisfy the predetermined criteria is significantly lower than that of a fusion target FT generated using an image whose parameters satisfy the predetermined criteria. Therefore, by executing S120, it is possible to prevent a fusion target FT from being generated with significantly reduced accuracy in position information.

When comparing the fusion target FT generated in S125 with the fusion target FT generated in S130, the accuracy of position information of the fusion target FT generated in S130 may be lower than the accuracy of position information of the fusion target FT generated in S125. This is because the fusion target FT generated in S130 is generated using a captured image acquired at a time different from the time the point cloud data was acquired. Information on whether the fusion target FT was generated through step S125 or S130 is used in a determination process described later.

### A2-2. Determination Process

A determination process shown in FIG. 3 is a process for determining whether to execute collision avoidance control after the fusion target FT is generated. The determination process is executed when the fusion target generation process is completed.

In S135, the determination unit 14 calculates a predicted movement trajectories of the own vehicle VC and the object target TG. The predicted movement trajectory of the own vehicle VC is calculated using the yaw rate, speed, and steering angle of the own vehicle VC acquired by the vehicle condition sensor 30. The predicted movement trajectory of the object target TG is calculated using the fusion target FT generated in time series.

In S140, the determination unit 14 forms a three-dimensional object of the own vehicle VC and a three-dimensional object of the object target TG in a virtual three-dimensional coordinate system (not shown). The three-dimensional coordinate system is a coordinate system configured in three dimensions: a length direction (front-rear direction) of the own vehicle VC, a width direction of the own vehicle VC, and an elapsed time from a predetermined time. The three-dimensional objects of the own vehicle VC and the object target TG are formed based on the predicted movement trajectories of the own vehicle VC and the object target TG calculated in S135.

In S145, the determination unit 14 determines whether the own vehicle VC and the object target TG intersect with each other. Whether the own vehicle VC and the object target TG intersect is determined by whether the three-dimensional object of the own vehicle VC and the three-dimensional object of the object target TG formed in the three-dimensional coordinate system described above intersect. If it is determined that the own vehicle VC and the other object target TG do not intersect (S145: No), the process returns to S105.

If it is determined that the own vehicle VC and the other object target TG will intersect (S145: Yes), the determination unit 14 calculates a time to collision (TTC) in S150. The time to collision means a time until the own vehicle VC and the object target TG collide if the own vehicle VC and the object target TG maintain their current speeds. The time to collision may be calculated, for example, by dividing a straight-line distance from the current position of the own vehicle VC to the object target TG by the relative speed of the object target TG with respect to the own vehicle VC.

In S155, the determination unit 14 determines whether a situation calls for the execution of collision avoidance control. Whether a situation exists in which collision avoidance control should be performed may be determined, for example, using a machine learning model that has been trained in advance, taking into account the calculated time to collision and the driving conditions of the own vehicle VC and the object target TG. The machine learning model may be, for example, a convolutional neural network (CNN) or a recurrent neural network (RNN). A situation in which collision avoidance control is to be executed may be, for example, a situation in which the own vehicle VC can avoid a collision with the object target TG by executing collision avoidance control. A situation in which collision avoidance control is not executed may be, for example, a situation in which the own vehicle VC cannot avoid a collision with the other object target TG even if collision avoidance control is executed, such as a situation in which the object target TG approaches the own vehicle VC from behind and collides with it. If it is determined that the situation does not require the execution of collision avoidance control (S155: No), the process returns to S105.

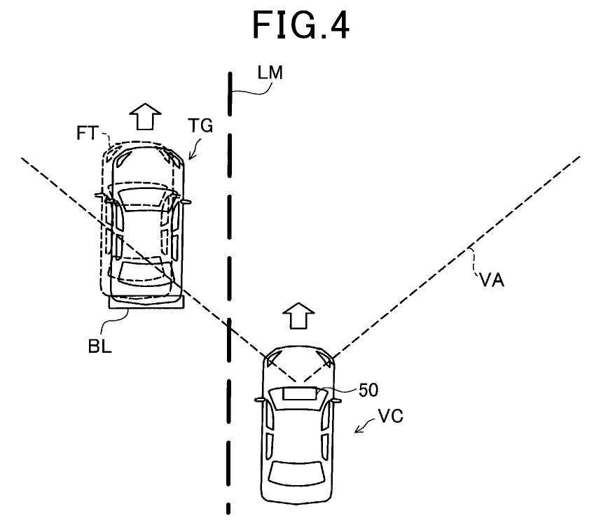

If it is determined that the situation requires the execution of collision avoidance control (S155: Yes), the determination unit 14 determines whether a situation is such that the own vehicle VC will collide with the object target TG traveling ahead of the own vehicle VC in S160. Whether a collision situation exists with the object target TG traveling ahead of the own vehicle VC may be determined by taking into consideration, for example, the distance from the own vehicle VC to the object target TG along the longitudinal direction (also called the front-to-rear direction) of the own vehicle VC, and the distance from the own vehicle VC to the object target TG along the width direction of the own vehicle VC. As shown in FIG. 4, the object target TG in the present embodiment is a vehicle traveling ahead of the own vehicle VC, more specifically, a vehicle traveling ahead of the own vehicle VC in a lane adjacent to a lane in which the own vehicle VC is traveling.

If it is determined that the vehicle VC is in a situation where it will collide with the object target TG traveling ahead of the vehicle VC (S160: Yes), the determination unit 14 determines whether a part of the object target TG is located outside an angle of view VA of the camera 50 in S165. The angle of view VA here refers to an angle of view in the horizontal direction, that is, a range in which the camera 50 can capture an image in the horizontal direction. As shown in FIG. 4, the camera 50 in the present embodiment is mounted near the upper edge of the windshield of the own vehicle VC, and the angle of view VA of the camera 50 is a predetermined range ahead of the own vehicle VC. The angle of view VA may be, for example, 100°. In an example shown in FIG. 4, a part of the object target TG is located outside the angle of view VA of the camera 50. The part of the object target TG located outside the angle of view VA of the camera 50 includes a rear-end portion BL of the object target TG.

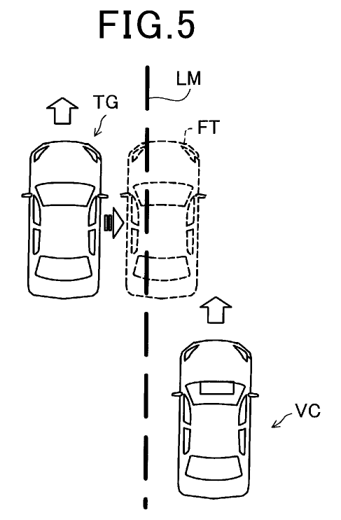

If a part of the object target TG is located outside the angle of view VA of the camera 50, it is highly likely that the captured image used to generate the fusion target FT was acquired when the detection accuracy of the camera 50 was low. The fusion target FT generated using such a captured image may have reduced accuracy in position information. Here, an example in which the accuracy of position information of the fusion target FT is reduced will be described with reference to FIG. 5. As shown in FIG. 5, the object target TG is traveling in a lane adjacent to the own vehicle VC. However, as shown in FIG. 5, the fusion target FT, whose position information has a reduced accuracy, is erroneously recognized as being located across a lane boundary line LM between the own vehicle VC and the object target TG. In this case, smooth traveling of the own vehicle VC may be hindered by executing collision avoidance control against an imaginary object target TG.

Therefore, as shown in FIG. 3, if it is determined that a part of the other object target TG is located outside the angle of view VA of the camera 50 (S165: Yes), the collision avoidance control suppression unit 15 suppresses collision avoidance control from being executed in S170. In other words, even if the determination unit 14 determines that there is a risk of the own vehicle VC colliding with the object target TG traveling ahead of the own vehicle VC (S160: Yes), if a part of the object target TG is located outside the angle of view VA of the camera 50 (S165: Yes), the collision avoidance control suppression unit 15 suppresses collision avoidance control from being executed. This makes it possible to suppress collision avoidance control from being executed in a situation where the accuracy of position information of the fusion target FT has decreased.

If it is determined that a part of the object target TG is not located outside the angle of view VA of the camera 50, i.e., that the entire object target TG is within the angle of view VA of the camera 50 (S165: No), the determination unit 14 determines whether the fusion target FT at the first period has been generated using the captured image acquired at the second period in S175, i.e., whether the fusion target FT has been generated in the above-mentioned S130.

As described above, the fusion target FT generated in S130 may have lower accuracy of position information compared to the fusion target FT generated in S125. Therefore, even if the fusion target FT at the first period is generated using the captured image acquired at the second period (S175: Yes), by executing the above-mentioned S170, it is possible to suppress the smooth running of the vehicle VC from being hindered.

If it is determined that there is no situation in which a collision will occur with the object target TG traveling ahead of the vehicle VC (S160: No), or if the fusion target FT at the first period is generated without using the image acquired at the second period (S175: No), the determination unit 14 determines whether the time to collision calculated in S150 is less than or equal to a predetermined threshold value in S180. If the time to collision is longer than a predetermined threshold, the collision may be avoided by the driver's steering or braking, therefore, collision avoidance control is not executed and the process returns to S105, thereby preventing the smooth traveling of the own vehicle VC from being hindered.

If it is determined in S150 that the time to collision calculated is equal to or less than the predetermined threshold value (S180: Yes), the braking device 60 executes collision avoidance control in S185.

According to the driving assistance device 100 described above, the collision avoidance control suppression unit 15 suppresses collision avoidance control from being executed when a part of the object target TG is located outside the angle of view VA of the camera 50, and therefore, it is possible to suppress collision avoidance control from being executed for a fusion target FT generated in a situation where a part of the object target TG is located outside the angle of view VA of the camera 50, i.e., a fusion target FT whose position information accuracy may be reduced compared to a normal fusion target FT. Therefore, unnecessary collision avoidance control can be suppressed from being executed for the imaginary object target TG. The normal fusion target FT here refers to a fusion target FT generated in a situation where the entire object target TG is located within the angle of view VA of the camera 50.

In addition, even if the determination unit 14 determines that there is a risk of the own vehicle VC colliding with the object target TG traveling ahead of the own vehicle VC, the collision avoidance control suppression unit 15 suppresses collision avoidance control from being executed if a part of the object target TG is located outside the angle of view VA of the camera 50, thereby suppressing unnecessary collision avoidance control from being executed in a situation where there is a risk of the own vehicle VC colliding with the object target TG traveling ahead of the own vehicle VC.

Further, since a part of the object target TG located outside the angle of view VA of the camera 50 includes the rear-end portion BL of the object target TG, it is possible to suppress collision avoidance control from being executed on a fusion target FT generated in a situation where the rear-end portion BL of the object target TG is located outside the angle of view VA of the camera 50, i.e., a fusion target FT whose position information accuracy may be reduced compared to that of a normal fusion target FT. The rear-end portion BL of the object target TG may contain information about the distance between the own vehicle VC and the object target TG, and is therefore a portion that should be given priority in consideration when determining whether to execute collision avoidance control. Therefore, the collision avoidance control suppression unit 15 can suppress unnecessary collision avoidance control from being executed on the fusion target FT whose position information has reduced accuracy when the part is located outside the angle of view VA of the camera 50.

In addition, when a fusion target FT at a first period is generated using an image acquired at a second period, the collision avoidance control suppression unit 15 suppresses collision avoidance control from being executed, thereby suppressing collision avoidance control from being executed for a fusion target FT at a time other than the time at which the image was acquired, i.e., a fusion target FT whose position information accuracy may be reduced compared to a normal fusion target FT. Therefore, unnecessary collision avoidance control can be suppressed from being executed for the imaginary object target TG. Note that the normal fusion target FT here refers to a fusion target FT at the first period that is generated using an image captured at the first period.

In addition, even if the determination unit 14 determines that there is a risk of the own vehicle VC colliding with the object target TG traveling ahead of the own vehicle VC, the collision avoidance control suppression unit 15 suppresses collision avoidance control from being executed if the fusion target FT at the first period is generated using the captured image acquired at the second period, thereby suppressing unnecessary collision avoidance control from being executed in a situation where there is a risk of the own vehicle VC colliding with the object target TG traveling ahead of the own vehicle VC.

Further, since the parameters relating to the captured image include information relating to the brightness of the captured image, it is possible to determine whether the captured image satisfies the predetermined criteria based on the brightness of the captured image. Therefore, it is possible to suppress a fusion target FT using an image captured by the camera 50 with reduced detection accuracy from being generated.

### B. Second Embodiment

A driving assistance device 100 in a second embodiment differs from the first embodiment in that S175 is omitted from the determination process of the first embodiment. The same processes as those in the first embodiment are denoted by the same reference numerals, and detailed descriptions thereof will be omitted.

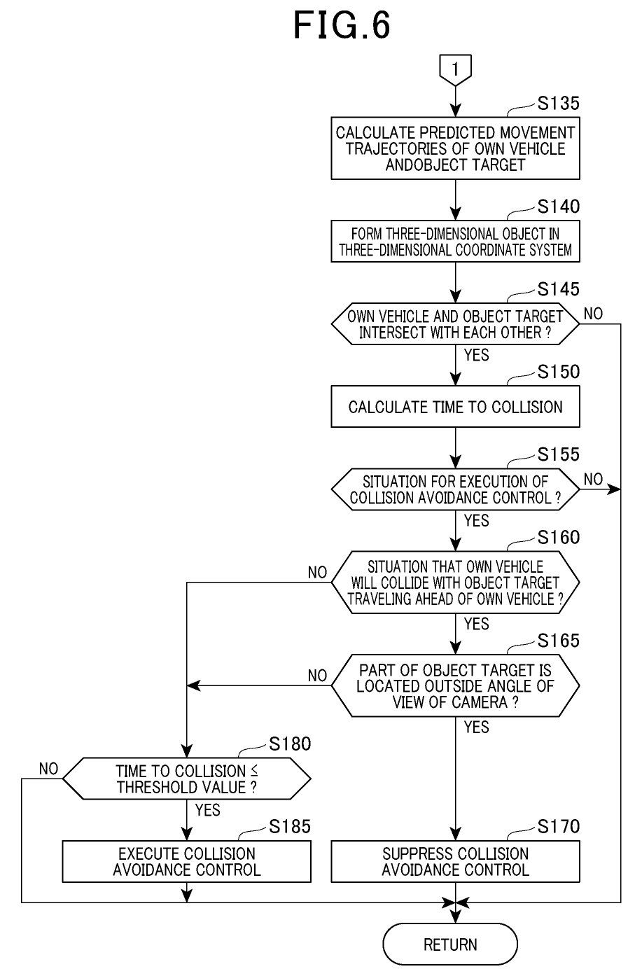

In a determination process of the second embodiment, as shown in FIG. 6, if it is determined that a part of the object target TG is not located outside the angle of view VA of the camera 50, that is, that the entire object target TG is within the angle of view VA of the camera 50 (S165: No), S180 is executed to determine whether the time to collision is equal to or less than the predetermined threshold value. That is, in the second embodiment, whether to execute or suppress collision avoidance control is determined regardless of whether a fusion target FT at the first period is generated using the captured image acquired at the second period.

According to the driving assistance device 100 described above, the same effects as those of the driving assistance device 100 of the first embodiment are achieved. In addition, in the second embodiment, whether to execute or suppress collision avoidance control is determined regardless of whether the fusion target FT at the first period is generated using the captured image acquired at the second period, therefore, processing related to whether to use the captured image acquired at the second period, such as S115, S120, and S130 in the fusion target generation processing, can be omitted. Therefore, it is possible to determine whether to execute or suppress collision avoidance control using a flow simpler than the collision avoidance control suppression process in the first embodiment.

### C. Third Embodiment

A driving assistance device 100 in a third embodiment differs from the first embodiment in that S165 is omitted from the determination process in the first embodiment. The same processes as those in the first and second embodiments are denoted by the same reference numerals, and detailed description thereof will be omitted.

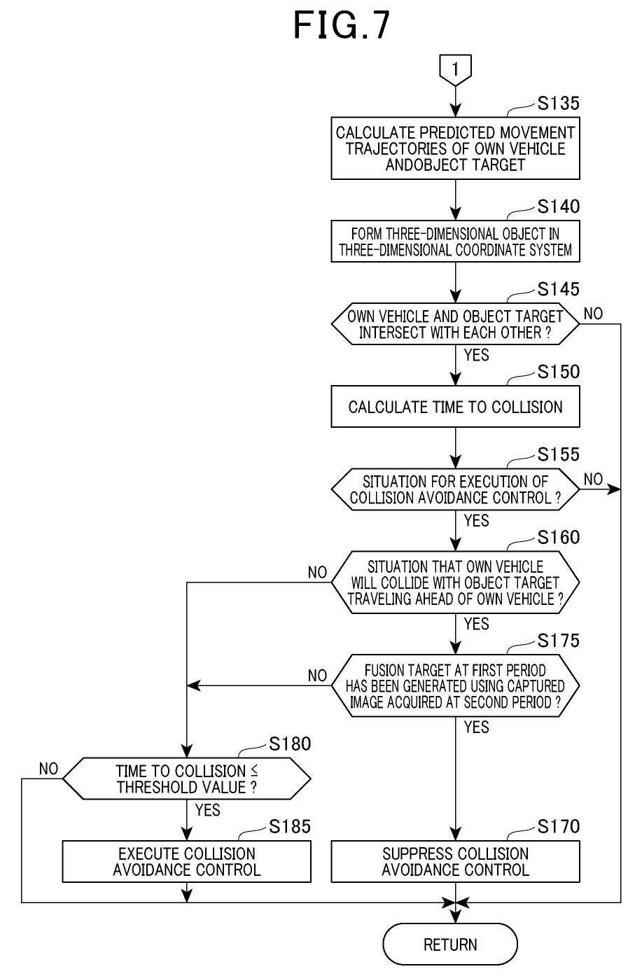

In a determination process of the third embodiment, as shown in FIG. 7, if it is determined that a collision situation exists with an object target TG traveling ahead of the own vehicle VC (S160: Yes), the above-mentioned S175 is executed. Then, if a fusion target FT at the first period is generated using the captured image acquired at the second period (S175: Yes), S170 is executed and the collision avoidance control suppression unit 15 suppresses collision avoidance control from being executed. That is, in the third embodiment, whether to execute or suppress collision avoidance control is determined regardless of whether a part of the object target TG is located outside the angle of view VA of the camera 50.

According to the driving assistance device 100 described above, the same effects as those of the driving assistance device 100 of the first embodiment are achieved. In addition, in the third embodiment, whether to execute or suppress collision avoidance control is determined regardless of whether the object target TG is located outside the angle of view VA of the camera 50, therefore, whether to execute or suppress collision avoidance control can be determined by a flow that omits S165 in the determination process of the first embodiment. For example, the present embodiment can be adopted when a plurality of cameras 50 are mounted on the own vehicle VC, making it difficult to imagine that the object target TG will be located outside the angle of view VA of the cameras 50.

### D. Other Embodiments

(D1) Although the object target TG is a vehicle in each embodiment, the present disclosure is not limited to this. The object target TG may be, for example, a pedestrian, an animal, or the like.

(D2) Although the driving assistance device 100 includes the determination unit 14 in each embodiment, this may be omitted in the present disclosure. Accordingly, in the collision avoidance control suppression process, steps related to whether the own vehicle VC will collide with the object target TG and whether collision avoidance control is to be executed may be omitted.

(D3) Although the millimeter-wave radar sensor 40 is used as a sensor for detecting the object target TG present around the own vehicle VC in each embodiment, the present disclosure is not limited to this. Alternatively, various sensors capable of generating point cloud data of an object target TG, such as Lidar (Light Detection and Ranging) or sonar, may be used.

(D4) Although a part of the object target TG located outside the angle of view VA of the camera 50 includes the rear-end portion BL of the object target TG in each embodiment, the present disclosure is not limited to this. A part of the object target TG located outside the angle of view VA of the camera 50 may be, for example, a front-end portion of the object target TG. A situation in which the front-end portion of the object target TG is located outside the angle of view VA of the camera 50 may be, for example, a situation in which the camera 50 is mounted on the side of the own vehicle VC and the angle of view VA is within a predetermined range on the side of the own vehicle VC.

(D5) Although collision avoidance control is performed by the braking device 60 applying a braking force to the own vehicle VC to decelerate the own vehicle VC until the own vehicle VC reaches or falls below a predetermined threshold speed in each embodiment, the present disclosure is not limited to this and various forms may be adopted. For example, the collision avoidance control may be performed by the braking device 60 applying a braking force to the own vehicle VC to stop the own vehicle VC. In addition, the own vehicle VC may have a configuration capable of outputting a warning sound, and collision avoidance control may be to output the warning sound to notify the driver that there is a risk of a collision. Further, collision avoidance control may be to apply a steering torque to the own vehicle VC so as to avoid a collision between the own vehicle VC and the object target TG. In this case, collision avoidance control may be executed in response to an instruction from the driving assistance device 100 to the steering device 70 via the in-vehicle network.

(D6) Although the parameters of the captured image include information about the brightness of the captured image in the present embodiment, the present disclosure is not limited to this. The parameters of the captured image may include various information such as saturation, brightness, hue, and resolution of the captured image. In addition, the parameters of the captured image may be obtained by converting the various pieces of information described above into scores. In this case, if the scored parameter is equal to or greater than a predetermined threshold, it may be determined that the parameter related to the captured image satisfies predetermined criteria.

The driving assistance device 100 and methods described in the present disclosure may be realized by a dedicated computer provided by configuring a processor and memory programmed to perform one or more functions embodied by the computer program. Alternatively, the driving assistance device 100 and method described in the present disclosure may be implemented by a dedicated computer provided by configuring a processor with one or more dedicated hardware logic circuits. Alternatively, the driving assistance device 100 and methods described in the present disclosure may be realized by one or more dedicated computers composed of a processor and memory programmed to perform one or more functions, in combination with a processor composed of one or more hardware logic circuits. In addition, the computer program may also be stored in a computer-readable, non-transitory tangible storage media as instructions to be performed by a computer. Note that the computer program may also be used in a form other than being installed in a vehicle, such as in a form that transmits data to a server.

The present disclosure can be realized in various forms other than the form of the driving assistance device 100. For example, it can be realized in the form of a driving assistance method, a collision avoidance suppression determination method, a fusion target generation method, and a determination method, or a computer program for realizing these methods and the driving assistance device 100.

The present disclosure is not limited to the above-described embodiments, and can be realized in various configurations without departing from the scope of the present disclosure. For example, the technical features in the embodiments corresponding to the technical features in each form described in the Summary column can be replaced or combined as appropriate in order to solve some or all of the above-mentioned problems or to achieve some or all of the above-mentioned effects. In addition, if a technical feature is not described as essential in the present specification, it may be deleted as appropriate.

The present disclosure may be realized, for example, in the following configurations.

### Configuration 1

A driving assistance device for a vehicle including:

a point cloud data acquisition unit that acquires point cloud data of an object target in time series using a sensor mounted on the vehicle;

an image acquisition unit that acquires a captured image of the object target in time series using a camera mounted on the vehicle;

a fusion unit that combines the captured image, parameters of which satisfy a predetermined criterion, with the point cloud data to generate a fusion target of the object target; and

a collision avoidance control suppression unit that suppresses collision avoidance control from being executed for avoiding a collision between the vehicle and the object target traveling ahead of the vehicle; wherein

the collision avoidance control suppression unit suppresses collision avoidance control from being executed when a part of the object target is located outside an angle of view of the camera.

### Configuration 2

The driving assistance device according to configuration 1, wherein

the driving assistance device further includes a determination unit that determines whether the vehicle is in a situation where there is a risk of collision with the object target traveling ahead of the vehicle, using the generated fusion target; and

the collision avoidance control suppression unit suppresses collision avoidance control from being executed when a part of the object target is located outside the angle of view of the camera, even if the determination unit determines that the vehicle is in a situation where there is a risk of collision.

### Configuration 3

The driving assistance device according to configuration 1 or 2, wherein

the part of the object target located outside the angle of view of the camera includes a rear-end part of the object target.

### Configuration 4

A driving assistance device for a vehicle including:

a point cloud data acquisition unit that acquires point cloud data of an object target in time series using a sensor mounted on the vehicle;

an image acquisition unit that acquires a captured image of the object target in time series using a camera mounted on the vehicle;

a fusion unit that combines the captured image, parameters of which satisfy a predetermined criterion, with the point cloud data to generate a fusion target of the object target; and

a collision avoidance control suppression unit that suppresses collision avoidance control from being executed for avoiding a collision between the vehicle and the object target traveling ahead of the vehicle; wherein

the fusion unit generates the fusion target at a first period by using the captured image acquired at a second period occurring earlier than the first period when the captured image is not acquired at the first period or when the parameters related to the captured image acquired at the first period do not satisfy the predetermined criterion; and

the collision avoidance control suppression unit suppresses the collision avoidance control from being executed when the fusion target at the first period is generated using the captured image acquired at the second period.

### Configuration 5

The driving assistance device according to configuration 4, wherein

the driving assistance device further includes a determination unit that determines whether the vehicle is in a situation where there is a risk of collision with the object target traveling ahead of the vehicle, using the generated fusion target; and

the collision avoidance control suppression unit suppresses the collision avoidance control from being executed when the fusion target at the first period is generated using the captured image acquired at the second period, even if the determination unit determines that the vehicle is in a situation where there is a risk of collision.

### Configuration 6

The driving assistance device according to any one of configurations 1 to 5, wherein

the parameters include information about a brightness of the captured image.

### Configuration 7

A computer program comprising:

a computer configured to perform the following:

a function of acquiring point cloud data of an object target in time series using a sensor mounted on a vehicle;

a function of acquiring a captured image of the object target in time series using a camera mounted on the vehicle;

a function of combining the captured image, parameters of which satisfy a predetermined criterion, with the point cloud data to generate a fusion target of the object target; and

a collision avoidance control suppression function of suppressing collision avoidance control from being executed for avoiding a collision between the vehicle and the object target traveling ahead of the vehicle; wherein

the collision avoidance control suppression function includes a function of suppressing collision avoidance control from being executed when a part of the object target is located outside an angle of view of the camera.

### Configuration 8

A computer program comprising:

a computer configured to perform the following:

a function of acquiring point cloud data of an object target in time series using a sensor mounted on a vehicle;

a function of acquiring a captured image of the object target in time series using a camera mounted on the vehicle;

a function of combining the captured image, parameters of which satisfy a predetermined criterion, with the point cloud data to generate a fusion target of the object target; and

a collision avoidance control suppression function of suppressing collision avoidance control from being executed for avoiding a collision between the vehicle and the object target traveling ahead of the vehicle; wherein

the fusion function includes a function of generating the fusion target at a first period by using the captured image acquired at a second period occurring earlier than the first period when the captured image is not acquired at the first period or when the parameters related to the captured image acquired at the first period do not satisfy the predetermined criterion; and

the collision avoidance control suppression function includes a function of suppressing the collision avoidance control from being executed when the fusion target at the first period is generated using the captured image acquired at the second period.

What is claimed is:

1. A driving assistance device for a vehicle comprising:
a point cloud data acquisition unit that acquires point cloud data of an object target in time series using a sensor mounted on the vehicle;
an image acquisition unit that acquires a captured image of the object target in time series using a camera mounted on the vehicle;
a fusion unit that combines the captured image, parameters of which satisfy a predetermined criterion, with the point cloud data to generate a fusion target of the object target; and
a collision avoidance control suppression unit that suppresses collision avoidance control from being executed for avoiding a collision between the vehicle and the object target traveling ahead of the vehicle; wherein
the collision avoidance control suppression unit suppresses collision avoidance control from being executed when a part of the object target is located outside an angle of view of the camera.

2. The driving assistance device according to claim 1, wherein
the driving assistance device further includes a determination unit that determines whether the vehicle is in a situation where there is a risk of collision with the object target traveling ahead of the vehicle, using the generated fusion target; and
the collision avoidance control suppression unit suppresses collision avoidance control from being executed when a part of the object target is located outside the angle of view of the camera, even if the determination unit determines that the vehicle is in a situation where there is a risk of collision.

3. The driving assistance device according to claim 1, wherein
the part of the object target located outside the angle of view of the camera includes a rear-end part of the object target.

4. A driving assistance device for a vehicle comprising:
a point cloud data acquisition unit that acquires point cloud data of an object target in time series using a sensor mounted on the vehicle;
an image acquisition unit that acquires a captured image of the object target in time series using a camera mounted on the vehicle;
a fusion unit that combines the captured image, parameters of which satisfy a predetermined criterion, with the point cloud data to generate a fusion target of the object target; and
a collision avoidance control suppression unit that suppresses collision avoidance control from being executed for avoiding a collision between the vehicle and the object target traveling ahead of the vehicle; wherein
the fusion unit generates the fusion target at a first period by using the captured image acquired at a second period occurring earlier than the first period when the captured image is not acquired at the first period or when the parameters related to the captured image acquired at the first period do not satisfy the predetermined criterion; and
the collision avoidance control suppression unit suppresses the collision avoidance control from being executed when the fusion target at the first period is generated using the captured image acquired at the second period.

5. The driving assistance device according to claim 4, wherein
the driving assistance device further includes a determination unit that determines whether the vehicle is in a situation where there is a risk of collision with the object target traveling ahead of the vehicle, using the generated fusion target; and
the collision avoidance control suppression unit suppresses the collision avoidance control from being executed when the fusion target at the first period is generated using the captured image acquired at the second period, even if the determination unit determines that the vehicle is in a situation where there is a risk of collision.

6. The driving assistance device according to claim 1, wherein
the parameters include information about a brightness of the captured image.

7. A computer program comprising:
a computer configured to perform the following:
a function of acquiring point cloud data of an object target in time series using a sensor mounted on a vehicle;
a function of acquiring a captured image of the object target in time series using a camera mounted on the vehicle;
a function of combining the captured image, parameters of which satisfy a predetermined criterion, with the point cloud data to generate a fusion target of the object target; and
a collision avoidance control suppression function of suppressing collision avoidance control from being executed for avoiding a collision between the vehicle and the object target traveling ahead of the vehicle; wherein
the collision avoidance control suppression function includes a function of suppressing collision avoidance control from being executed when a part of the object target is located outside an angle of view of the camera.

8. A computer program comprising:
a computer configured to perform the following:
a function of acquiring point cloud data of an object target in time series using a sensor mounted on a vehicle;
a function of acquiring a captured image of the object target in time series using a camera mounted on the vehicle;
a fusion function of combining the captured image, parameters of which satisfy a predetermined criterion, with the point cloud data to generate a fusion target of the object target; and
a collision avoidance control suppression function of suppressing collision avoidance control from being executed for avoiding a collision between the vehicle and the object target traveling ahead of the vehicle; wherein
the fusion function includes a function of generating the fusion target at a first period by using the captured image acquired at a second period occurring earlier than the first period when the captured image is not acquired at the first period or when the parameters related to the captured image acquired at the first period do not satisfy the predetermined criterion; and
the collision avoidance control suppression function includes a function of suppressing the collision avoidance control from being executed when the fusion target at the first period is generated using the captured image acquired at the second period.
